(19) United States
(12) Patent Application Publication
(10) Pub. No.: US 2005/0177453 A1
(43) Pub. Date: Aug. 11, 2005

(54) Method and system for customization of consumer products

(76) Inventors: John T. Anton, Phoenix, AZ (US); Sami D. Nakazono, Phoenix, AZ (US)

Correspondence Address: R. Lee Fraley;Snell & Wilmer L.L.P., One Arizona Center, 400 E. Van Buren, Phoenix, AZ, 85044-2202, US

(21) Appl. No.: 11/003,044

(22) Filed: Dec. 2, 2004

Related U.S. Application Data
(60) Provisional application No. 60/526,258, filed on Dec. 2, 2003.

(51) Int. Cl. G06F 17/60

(52) U.S. Cl. 705/26

(57) ABSTRACT

A method and system for customization of consumer products, such as the creating, designing and/or selecting of artwork, graphic elements and/or designs for consumer products, are provided. An exemplary method and system can allow for a customer to select, design, save and/or purchase customized products more efficiently, and enable merchandizing and operations personnel to be able to more readily create, approve and publicly display products and related designs without possessing extensive technical capabilities. In accordance with an exemplary embodiment, a system for customization of consumer products can comprise a database configured with a plurality of modules, such as an administration tool module, a home or anchor website module, a customization module, an order processing module, an order management module, and/or an order tracking module. To facilitate a more efficient customization and design process, an exemplary system for customizing consumer products comprises an application configured to use the capabilities of a local computer of the consumer to provide substantially instantaneous design changes and modifications for evaluation by the customer.

### CROSS-REFERENCE TO RELATED APPLICATIONS

This application claims priority to, and benefit of, U.S. Provisional Application No. 60,526,258, filed on Dec. 2, 2003, and entitled “Method and System for Customizing of Consumer Products.”

### FIELD OF INVENTION

The present invention relates to the customization of consumer products. More particularly, the present invention relates to a method and system for creating, designing and/or selecting artwork, graphic elements and designs for consumer products.

### BACKGROUND OF THE INVENTION

In the customization of consumer products, such as the inclusion of logos, graphics or other artwork or design elements in the garment industry, consumers typically visit a garment/T-shirt shop in a mall or similar retail establishment, select a logo or have their design specially created by an artist, and then wait up to two to three weeks or more to have the garments printed before returning to pick up the finished goods. In addition to the design and printing process being very time consuming, the consumer is generally at the mercy of the retail shop in terms of art design and selection as well as scheduling. Due to the limitations of operating a retail establishment in a fixed location, the retail shop often has a more limited supply of products available, often requiring the goods to be shipped.

Further, the consumer bears the cost of both the shipping the goods back to the retail store for pick-up, and the overhead of the retail establishment in acquiring the garments.

Recently, attempts have been made to create “online stores” for the production and distribution of customized garments. While such e-commerce solutions can avoid many of the problems of the fixed location establishment, these online stores have created a new generation of problems. For example, in most cases, the customer must have the technological or business expertise to create or otherwise acquire their own design, which they then must “upload” to the website for placement on a garment; in other cases customers are required to send a file containing their designs through electronic mail, and then await telephonic or electronic mail confirmation. On other instances, although the customer may choose graphic elements of the design for placement on a garment, the customers have difficulty in viewing the proposed final products in their entirety. Unfortunately, customers are also often required to contact the garment supplier by telephone or additional electronic mail messages to obtain pricing information for any proposed customized garments. More notably, such online stores utilize out-dated technology that requires “server interaction” for each step of the design process, greatly slowing the selection and design process for the customer.

### SUMMARY OF THE INVENTION

In accordance with various aspects of the present invention, a method and system for customization of consumer products, such as the creating, designing and/or selecting of design elements, such as artwork, graphic elements, text and/or other like designs, for implementing on consumer products are provided. An exemplary method and system can allow for a customer to select, design, save, obtain quotes for and/or purchase customized products, such as garments including t-shirts and branded apparel, more efficiently. In addition, an exemplary method and system can enable merchandizing and operations personnel to be able to more readily create, approve and publicly display products and related designs on a website without possessing extensive technical capabilities.

In accordance with an exemplary embodiment, a system for customizing consumer products can comprise a plurality of modules, such as an administration tool module, a home or anchor website module, a customization module, an order processing module, an order management module, and/or an order tracking module. To facilitate a more efficient customization and design process, an exemplary system for customizing consumer products comprises an application configured with the ability to utilize a local computer of the consumer to provide substantially instantaneous design changes and modifications for evaluation and selection by the customer without requiring host server interaction.

### BRIEF DESCRIPTION OF THE DRAWINGS

A more complete understanding of the present invention may be derived by referring to the detailed description when considered in connection with the Figures, where like reference numbers refer to similar elements throughout the Figures, and:

FIG. 1 illustrates a block diagram of an exemplary system for customization of consumer products in accordance with an exemplary embodiment of the present invention;

FIG. 2 illustrates a block diagram of an exemplary customization module in accordance with an exemplary embodiment of the present invention; and

FIG. 3 illustrates an exemplary customization screen in accordance with an exemplary embodiment of the present invention.

### DETAILED DESCRIPTION OF EXEMPLARY EMBODIMENTS OF THE INVENTION

The present invention may be described herein in terms of various components, modules and processing steps. It should be appreciated that such components, modules and steps may be realized by any number of hardware components configured to perform the specified functions. For example, the present invention may employ various display screens, input/output devices and the like, which may carry out a variety of functions under the control of one or more microprocessor-based control systems or other control devices. In addition, the present invention may be practiced in any number of consumer product contexts and that the exemplary embodiments relating to T-shirts as described herein are merely a few of the exemplary applications for the invention. For example, the principles, elements and features of the exemplary systems and methods discussed may be applied to any other articles of clothing, including jackets, sweatshirts, sweatpants, shorts, hats, socks and other like clothing apparel. In addition, the principles, elements and features of the exemplary systems and methods discussed may also be applied to other industries where the customization of products is desirable, such as the construction industry, e.g., for customizing interior finishes and wall coverings such as paint or wallpaper, cabinetry, fireplaces, plumbing fixtures, and/or to the interior design industry, e.g., for providing floor plan/room views for adding and arranging similar interior design elements, furniture and window coverings and treatments and the like.

In addition, for the sake of brevity, conventional data networking, application development and other functional aspects of the customization system (and components of the individual operating components of the exemplary systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical customization system.

In accordance with various aspects of the present invention, a method and system for customization of consumer products, such as the creating, designing and/or selecting of design elements, such as artwork, graphic elements, photographic images, holographic images, text and/or other like designs, for consumer products are provided. An exemplary method and system can allow for a customer to select, design, save and/or purchase customized products, such as garments including t-shirts and branded apparel, more efficiently. In addition, an exemplary method and system can enable merchandizing and operations personnel to be able to more readily create, approve and publicly display products and related designs on a website without possessing extensive technical capabilities.

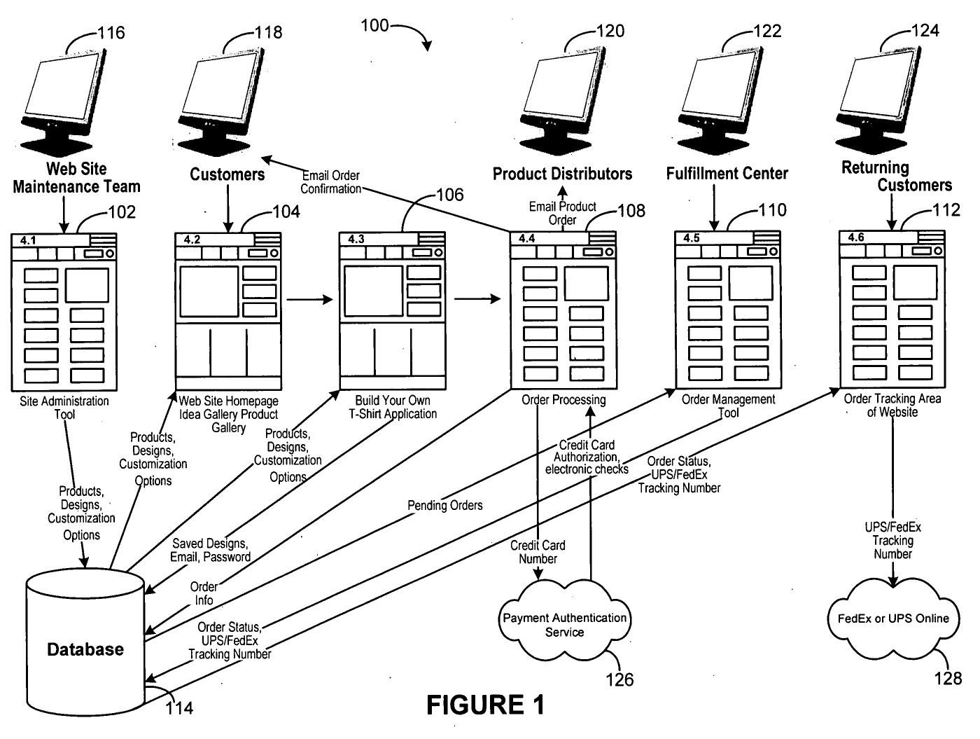

In accordance with an exemplary embodiment, with reference to a block diagram illustrated in FIG. 1, a system 100 for customization of consumer products can comprise a database configured with a plurality of software modules configured for managing, designing, selecting and/or ordering a customized product. For example, system 100 can comprise a database 114 and a plurality of modules, such as an administration tool module 102, a home or anchor website module 104, and a customization selection module 106. To facilitate ordering of customized products, system 100 can also comprise one or more order-based modules, such as an order processing module 108, an order management module 110, and/or an order tracking module 112. Database 114 is configured to receive, store and deliver data and information from administration tool module 102 and/or the plurality of other modules 104-112. Database 114 can comprise any conventional computer database system having various storage capabilities, and can be made up of a single database or a plurality of databases configured together in a database system, e.g., individual databases for each or any one of modules 104-112.

Administration tool module 102 is configured to enable an administrator to manage data and information for one or more websites corresponding to online stores, including data and information relating to, for example, the consumer products and articles offered for sale, the graphic art elements and designs available for selection, and the other customization options available for customization on the consumer products and articles. Administration tool module 102 can reside on a host server, or on a local server relative to the one or more websites. Administration tool module 102 can be suitably accessed by administrative and/or maintenance personnel from an input/output interface 116, e.g., by a website maintenance team.

Through use of administration tool module 102, an administrator can suitably add, update, and/or remove product categories and subcategories as well as design categories and subcategories offered through each website/online store. In addition, through use of administration tool module 102, an administrator can suitably add, update, and/or remove products offered to customers from a selected website. For example, for each product, the name and description can be entered, an image can be uploaded, a category and subcategory can be assigned, and/or keyword information can be entered as well as any additional information about the product, e.g., sizes available, colors available, price, and/or minimum quantity and the like.

Administration tool 102 can also enable an administrator to suitably add, update, and/or remove sample designs, templates and fonts for use in a design idea gallery. For example, for each design and/or template, a name can be entered, a category and subcategory can be assigned, and/or keyword information can be entered as well as any additional information about the design, templates or fonts, such a multiple colors or other options that may be available. Such sample designs, templates and/or fonts can be configured for control or modification only by the administrator to prevent edit by consumers, or open for edit and modification by all or selected consumers.

Administration tool 102 can also enable an administrator to suitably assign designs and products to a particular website, e.g., general, military, fraternal, automobile or other clubs or organizations, within a design idea gallery. Thus, each website can have featured items, options and special characteristics or promotions particular to that website, displayed prominently on a homepage for that website or other designated web pages. The managed data and information, such as product categories, offered products, sample designs, templates and fonts, and/or other related ordering information and saved design information can also be archived to database 114.

Home module 104 is configured to provide one or more homepages for facilitating customization by one or more customer, such as through an input/output interface 118 comprising, for example a computer. The computer may include any suitable personal computer, network computer, workstation, minicomputer, mainframe or the like. The computer can be in a home or business environment with access to a network. In an exemplary embodiment, access through input/output interface 118 is through a network or the Internet through a commercially-available web-browser software package.

In accordance with an exemplary embodiment, home module 104 comprises one or more homepages for websites, each having an idea gallery and product gallery configured for market specific elements. For example, various homepages can be provided, with each targeted to a different customer group or specific market through distinctive branding for each website. In addition, some or all of the homepages can be suitably linked to the same customization selection module 106, e.g., a MAKE YOUR OWN T-shirt application, and can draw information from centrally accessible database 114. For example, each homepage of a website can be branded with its own distinctive colors and logo or other source identifiers.

Any or all product catalog and design idea gallery pages can be dynamically generated from database 114 for each homepage. In addition, each homepage can list the featured items as identified in database 114, e.g. as selected in administration tool module 102. This feature can allow a customer to select, e.g., by clicking on, a featured item or an item from the product catalog or design gallery to start customization selection module 106, e.g., the MAKE YOUR OWN T-shirt application, with a corresponding selection. The customer can then search the website, with a results page be configured to include all matching products from the catalog, all matching designs from the gallery, and/or all matching miscellaneous web pages, such as a help section or other desired information.

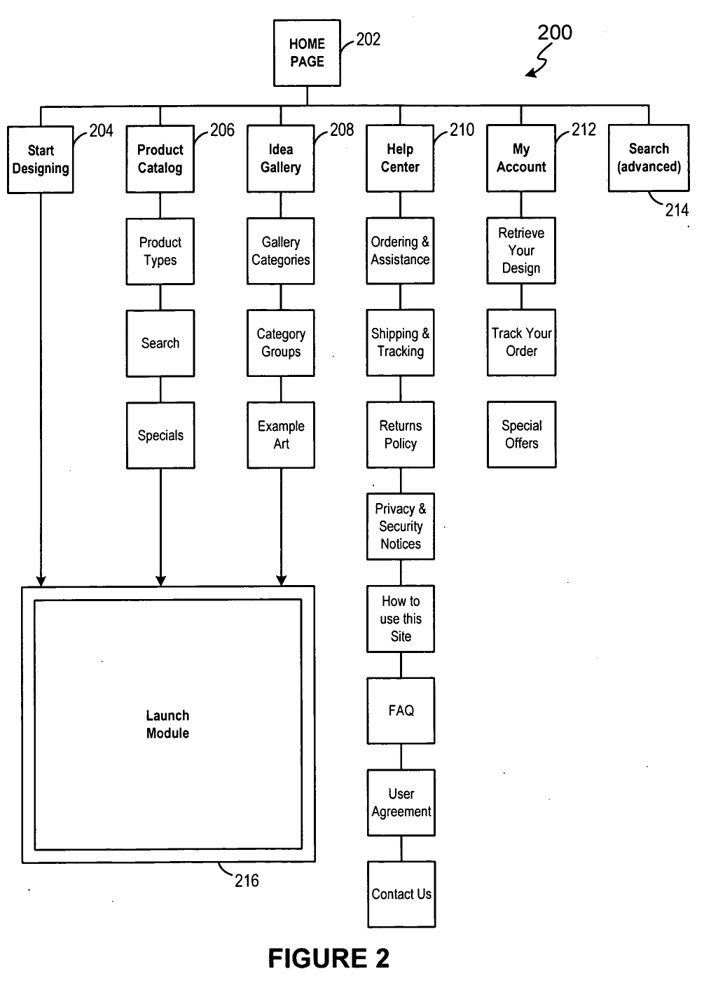

A home module 104 can also suitably allow a customer to navigate within the website to design artwork and graphic elements for products, select products, generate ideas, obtain help, check their accounts, and/or conduct a search for any other information desired. For example, with reference to FIG. 2, a block diagram of a home module 200 for navigation of content flow from one or more customer options is illustrated. At a home page 202, a customer can select a plurality of options, such as through one or more icons or other designations within home page 202. For example, a customer can choose a start designing component 204, a product catalog component 206, and/or an idea gallery component 208, each being coupled to a launch module 216 configured to initiate the customization process. In addition, a customer can also choose a help center component 210, an accounting component 212, and/or a search component 214 that are configured to provide additional assistance and guidance to the customer during the customization process. Additional or fewer components can be included within various exemplary embodiments, i.e., an exemplary home module 200 does not require any one of modules 204, 206, 208, 210, 212 or 214 to be present.

Selection of start designing component 204 can allow for a customer to proceed to launch module 216, for example, to proceed directly to customization module 106 to allow for a customer to customize and create their own products, e.g., to begin customization of T-shirts. Such a process of proceeding directly to launch module 216 is more suited to instances in which the customer has already determined the desired consumer product and design elements to be selected.

In instances where the customer has not already determined the desired consumer product to be customized, product catalog component 206 can offer a variety of product types, allowing searching within the product types, and/or offer specials, before allowing for a customer to proceed directly to launch module 216. For example, in a garment industry application, customers can select between product types such as men's wear, women's wear, sports shirts, athletic wear, outerwear, headwear and the like. Searches can also be conducted within a product type, such as searches within athletic wear to identify sweatshirts, sweatpants, athletic shorts and other kinds of athletic wear.

To assist a customer in choosing a suitably design element, selection of idea gallery component 208 can lead a customer to one or more gallery categories such as featured designs, athletics, events, types of organizations, businesses, colleges and universities and other like categories. Within the gallery categories, idea gallery component can provide a listing of category groups, e.g., within an events categories, event groups such as weddings, family reunions, anniversaries, graduations and the like can be identified. Once a category and a group within the category are selected, idea gallery component 208 can provide example artwork, text and other graphic elements for product design idea generation before the customer proceeds directly to launch module 216 to begin actual customization.

With respect to other features designed to provide assistance or guidance during the customization process, help center component 210 can suitably provide ordering and assistance, shipping and tracking capabilities, and/or other additional customer information, such as a returns policy, privacy and security notices, directions on how to use the website, a FAQ section, a user agreement and/or information to contact the host provider. Selection of accounting component 212 can enable a customer to suitably retrieve previous or current product designs, and/or track an accompanying order, including outstanding payments or balances due. In addition to tracking previous history and or account information, returning customers can also suitably participate in special offers, e.g., customers can participate in a frequent customer awards program that rewards the customers with discounts or free merchandise similar to other “frequent” shopper programs. In the event that the customer cannot readily find the component desired, customer can suitably utilize search component 214 to conduct an overall search of the website for desired information using various simplified and/or advanced computer word search techniques. Components 204, 206, 208, 210, 212 and/or 214 can be suitably available on not only home page 202, but also on every corresponding web page for each of components 204-213, to enable selection by a customer.

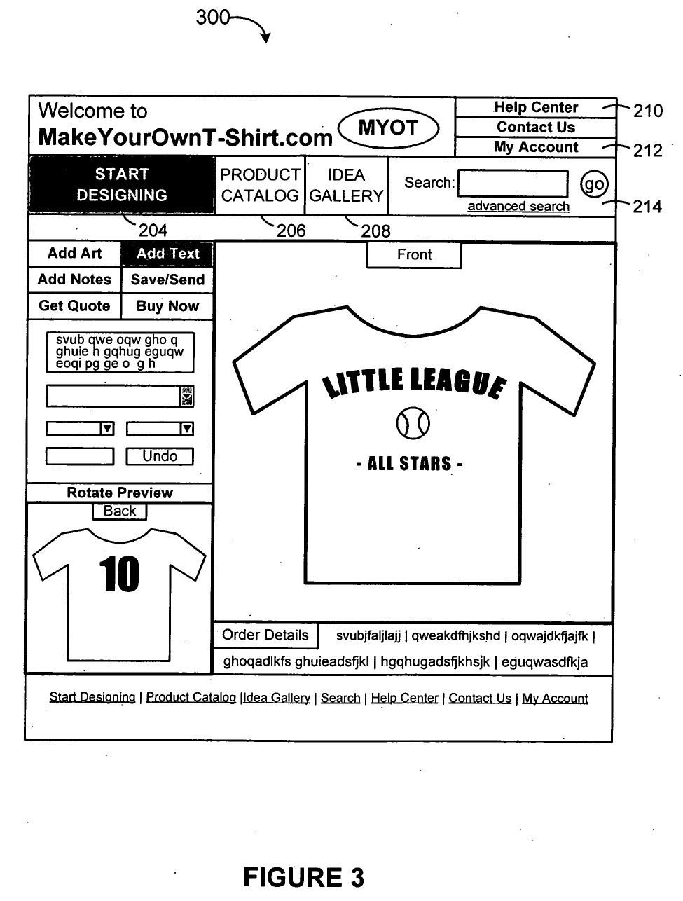

Once a customer is ready to start designing a product, launch module 216 can suitably transfer a customer from home module 104 to customization selection module 106 to allow for the customer to customize and create their own products, e.g., T-shirts, including the specifying and selecting of different types of products, specifying and altering of designs, text, and color or other like customization criteria. Customization selection module 106 can comprise one or more operating applications comprising customization web pages to allow a customer to customize and create new products. For example, in accordance with an exemplary embodiment, with additional reference to FIG. 3, an exemplary customization web page can comprise a MAKE YOUR OWN T-shirt application 300 that suitably provides customization of a product such as T-shirts. Application 300 is provided merely for illustrative purposes, and can be configured in various other manners for the customization of other types of consumer products and industry applications. For example, application 300 can also be suitably configured for customization of design elements for other types of garments, or for different types of consumer goods, such as coffee cups or mugs, license plates, interior or exterior home furnishings or any other type of consumer product.

While customization selection module 106 can allow for information to be procured through “server interaction” for each step of the design process, such a technique can greatly slow the selection and design process for the customer. However, in accordance with an exemplary embodiment, customization selection module 106 includes one or more applications configured with the ability to utilize the capabilities of a local computer of the consumer, for example, the local power, software, memory or any other local capabilities, to provide a more interactive and intuitive interface.

An application can suitably integrate various design elements within database 114, and then utilize the capabilities of the local computer of the consumer to instantaneously display the design elements on the consumer product, thus allowing for substantially instantaneous modification of the design elements for viewing by the customer. For example, in accordance with an exemplary embodiment, “html” portions of the website containing exemplary design elements, vector art software applications, and flash-based applications can be suitably integrated in order to provide the user with a seamless experience as the user navigates through the website. Such vector art software applications can comprise any graphic or art software or application that permits design elements to be added and manipulated or otherwise modified individually. Once transmitted from database 114, the flash application suitably loads the various possible design elements and product types individually, i.e., the flash application isolates the design elements to later be selected by the customer. With flash software residing within input/output interface 118 of a customer such that the various pre-loaded design elements are temporarily stored locally with the customer, such individual design elements can be quickly selected and interactively displayed on the consumer product. In other words, through the use of the capabilities of the local computer, the customer can substantially instantaneously revise, update and edit design changes and view the modifications to the customized product without waiting for server interaction.

In accordance with an exemplary embodiment, the flash application can comprise any flash-based application that can be suitably integrated with internet protocols and the like. For example, the flash application can comprise a version “Flash 6” as commercially available from Macromedia, Inc, or any other similar application now known or hereinafter developed that performs similar flash-functionality.

In accordance with other exemplary embodiments, to utilize the capabilities of local interface 118, customization selection module 106 can also suitably replace or supplement a flash application with other similar software applications, such as dynamic “html” (“DHTML”) that can exhibit some of the same functions or characteristics of the flash application.

Moreover, in accordance with other exemplary embodiments, rather than temporary type applications, the design elements and product types and other customization data and information can also permanently stored, e.g., on a local hard drive or other like medium capable of storing data and information, to allow substantially instantaneous access to a user. In such permanent applications, additional artwork or graphic modifying applications are required by the local computer to enable the customization. Accordingly, customization selection module 106 can be configured with any software application that utilizes the capabilities of local computer 118 to suitably integrate design elements for substantially instantaneous retrieval by a customer during customization without requiring access to a host server.

With additional reference to FIG. 3, MAKE YOUR OWN T-shirt application 300 suitably operates after start-designing component 204 is selected. Application 300 can be suitably branded for each focus group of a website, e.g., military, Greek fraternities, automobile clubs and the like, including for example different background and/or font colors or customized logos for each brand. The customer can select a product to design through product catalog component 206, changing this selection at any time, as well as browse idea gallery 208 of sample designs/templates and select one to customize. If desired, the customer can suitably contact a design team, and/or conduct a keyword search within the gallery of sample designs. Application 300 allows a customer to proceed back and forth between one or more components within customization module 106.

In accordance with an exemplary embodiment, use of the capabilities of local computer 118 can begin once start-designing component 204 is selected. As a result, substantially instantaneous changing of various design parameters and criteria can be realized. For example, changes to the size of selected artwork, the color of the artwork, as well as its manipulation through alignment and rotational actions can be configured with flash applications to provide substantially instantaneous changing and updating of the customized design by using the capability of local computer 118, as opposed to requiring server interaction to upload design choices.

A customer can suitably register as a new user or login as a returning user on home page 202. Once registered, the customer can save a custom design and retrieve it at a later time utilizing database 114, for example, up to three months before the custom design is deleted, or any other suitable length of time. The customer can also create categories to organize any saved designs, with the saved designs being archived within database 114. For example, saved designs for which an order has not yet been placed can be made available online for one month or more since last accessed, with any designs for orders made available for up to a year or more since the order was processed.

During the design process, the customer can suitably switch between front, back, and any other relevant views for the product. The customer can suitably add artwork and graphic elements to the design, for example by browsing the sample art gallery, keyword searching the sample art gallery, and/or uploading a file from the customer's computer, i.e., input/output terminal 118. For example, graphic file formats supported by the customization module application 300 such as .bmp, .gif, .jpg, .tif, .doc, .ppt and/or vector file formats such as .wmf and/or .eps formats can be supported for uploading, as well as displaying and manipulating, such as sizing and rotating. Further, artwork and other graphic design elements can be suitably sent from the customer to the host server, e.g., an FTP site, via Internet mailing or other transfer, using formats such as in “psd”, “ppd”, “ai”, “wmf” or “cdr” and the like, with each being capable of being uploaded for later customization. The customer can also share their designs through Internet mailing to other customers through a link to the application page or through other like protocols. In addition to design selection, the customer can also suitably add desired text to the design.

The customer can also modify templates, artwork and text elements within customization module 106 in various manners. For example, using application 300, the customer can scale the element while keeping the proportions locked, change the width and the height independently, distort the proportions, rotate the element, swap the layers such as by moving the element, and change the color of the element, with or without the use of flash applications. In addition, for text elements, the customer can change the font, point size and effects, e.g., variable arcing, slanting of the text through use of the capabilities of the local computer. Such arcing and slanting features provide a unique characteristic feature available to customers for customization. Further, the customer can add notes and miscellaneous instructions to the design, as well as notes regarding printing and shipping. In addition, the customer can input the information necessary to print individualized names and numbers, and can change the quantity for each size desired and observe the price update immediately. Upon finishing the design and choosing the quantities to be ordered, the customer can proceed to the order page through order processing module 108.

Order processing module 108 is configured to enable the customer to place their order, as well as provide integration with a payment authentication/processing service and a back-end order fulfillment system. In addition, an information collection form page can be provided to collect customer name and address information, to obtain financial payment information such as credit card, banking information or other electronic payment account information, to collect purchase order information, to allow the ability to input notes to design, printing and shipping personnel, and/or to provide value tips. In addition, an information collection form page can also provide an option to increase quantity or decrease colors, options to select sponsorship for reduction in price and to select rush shipping for additional charge, with additional offerings of coupons and feedback opportunities. Assistance can also be provided in selecting a payment authorization service 126, and integration of the order page with payment authorization service 126. A “Thank You” page after order has been placed, a confirmation email to the customer including the details of their order, and/or an email to the product distributor including the number and types of items ordered can also be suitably generated by order processing module 108. Further, approved orders can be entered into database module 114, where the orders can be sent to product distributors interface 120 and accessed by order management tool module 110 and order tracking module 112.

Order management tool module 110 can allow an order fulfillment house or manufacturer through a fulfillment center interface 122 to view orders, download designs, and update the status of orders before proceeding to manufacturing of the products. For example, order management tool 110 can list all pending orders color-coded according to status, provide the ability to view the details of each order by clicking on the name of an order in the list, and provide the ability to change status of orders and enter UPS/FedEx tracking numbers when an order has been shipped.

Order tracking module 112 can suitably allow for customers through returning customers interface 124 to access order tracking areas through the tracking numbers provided when the order was made and to confirm when shipped, such as by communicating to a shipping company 128. Order tracking module 112 can utilize various conventional order tracking techniques and process for facilitating the tracking of orders. In addition, a customer feedback system can also be provided to obtain information regarding the ordering experience. For example, after shipping of the customized products and receipt by the consumer, an inquiry, e.g., by electronic mail, can be sent to the consumer that makes a general or specific inquiry about the recent purchase and/or allows the consumer to provide feedback regarding the nature of the products, the ordering process or any other information relevant to the consumer products purchase.

The present invention has been described above with reference to various exemplary embodiments. However, those skilled in the art will recognize that changes and modifications may be made to the exemplary embodiments without departing from the scope of the present invention. For example, the various operational steps, as well as the components for carrying out the operational steps, may be implemented in alternate ways depending upon the particular application or in consideration of any number of cost functions associated with the operation of the system, e.g., various of the steps may be deleted, modified, or combined with other steps. In addition, interfaces 116, 118, 120, 122 and 124 can comprise any convention user interface and/or input/output terminal, configured to communicate with the exemplary system for customization through any conventional communication network or protocol. Further, the exemplary systems are suitably scalable to handle any desired quantity of data, artwork designs and the like. These and other changes or modifications are intended to be included within the scope of the present invention.

1. A computer-based system for facilitating customization of consumer products, said system comprising:
a database configured for the storage of customizing data and information;
an administration tool module configured to enable the management of said customizable data and information by an administrator;
a home module configured to provide at least one home page for facilitating customization;
a customization selection module configured to allow a customer to select and design customizable products, said customization module configured to utilize capabilities of a local computer of the consumer to facilitate substantially instantaneous design changes during customization without requiring host server interaction; and
at least one order-based module configured for facilitating ordering of said consumer products, each of said administration tool module, said home module, said customization selection module and said at least one order-based module communicatively coupled to said database.

2. The system according to claim 1, wherein said administration module is configured to add, update and remove sample designs for use in an idea gallery.

3. The system according to claim 2, wherein said administration module is configured to assign said sample designs to each of a plurality of types of websites.

4. The system according to claim 1, wherein said home module is configured to target different customer groups through control of said administration tool module and customizable information stored in said database.

5. The system according to claim 1, wherein said home module comprises:
a start-designing component configured to directly initiate customization through a launch module;
a product catalog configured to offer a variety of product types and allowing searching within said product types prior to initiating said launch module; and
an idea gallery configured to lead a customer through gallery categories, provide a list of category groups, and provide exemplary artwork for idea generation prior to initiating said launch module.

6. The system according to claim 5, wherein said home module further comprises:
a help center component configured to provide ordering assistance, shipping and tracking capabilities, and customer particular information;
an accounting component configured to enable retrieval of previous product designs and track payment balances; and
a search component to provide customizable searches of product types and design elements within said system.

7. The system according to claim 5, wherein said home module comprises a launch module configured to transfer the customer to said customization selection module.

8. The system according to claim 1, wherein said capabilities of said local computer comprise using flash applications integrated with “html” portions and vector art software of said system to provide a substantially seamless navigation process.

9. The system according to claim 8, wherein said flash applications are configured to facilitate substantially instantaneous changes in design element sizes, types and colors, as well as rotational alignment and position while displayed on said consumer products.

10. The system according to claim 9, wherein said flash applications are configured to individually isolate said design elements for local retrieval by a customer without a host server interaction.

11. The system according to claim 10, wherein said customization selection module comprises a single application page configured to provide access to a plurality of design elements for substantially instantaneous customization.

12. The system according to claim 1, wherein said at least one order-based module comprises:
an order processing module configured to enable a customer to place orders for customized products, provide payment authentication and processing, and an order confirmation via electronic mail;
an order management tool module configured to allow an order fulfillment house to view orders, download design and update the status of orders before proceeding to manufacturing; and
an order tracking module configured to allow for returning customers to confirm at least one of order progress and shipping status.

13. An automated method for the customization of consumer product, said method comprising:
selecting a consumer product for customization from a plurality of consumer product types stored on a database;
selecting at least one design element from a plurality of design elements stored on said database for viewing on said consumer product;
changing characteristics with a customization selection module of said at least one of design element substantially instantaneously through use of capabilities of a local computer for said consumer without requiring host server interaction; and
selecting a final customized design for ordering said customizable product.

14. The method according to claim 13, wherein said automated method further comprises updating, editing and revising said plurality of design elements and said plurality of consumer product types through an administration tool module.

15. The method according to claim 14, wherein said updating, editing and revising can occur at a plurality of websites having different types of consumer products and design elements.

16. The method according to claim 13, wherein said method comprises selecting a start designing component to initiate customization through a launch module.

17. The method according to claim 13, wherein said selecting a consumer product comprises selecting a product catalog configured to illustrate said plurality of product types and allow searching prior to initiating customization through a launch module.

18. The method according to claim 13, wherein said selecting at least one design element comprises selecting an idea gallery configured to facilitate viewing and selection of one category and group from a plurality of categories and groups, and providing a plurality of design elements corresponding to said selected category and group prior to initiating customization through a launch module.

19. The method according to claim 13, wherein said method further comprises:
providing ordering assistance, shipping and tracking capabilities through a help center component;
enabling retrieval of previous product designs and payment history information through an accounting component; and
providing customizable searches of product types and design elements.

20. The method according to claim 13, wherein said changing characteristics with a customization selection module comprises individually isolating said plurality of design elements with flash applications for local retrieval by a customer without host server interaction.

21. The method according to claim 20, wherein said changing characteristics with a customization selection module occurs within a single application page configured to provide access to said plurality of product types and said plurality of design elements for substantially instantaneous viewing of changes made during customization of said consumer product.

22. The method according to claim 13, wherein said selecting a final customized design for ordering comprises placing orders for customized products through an order processing module with payment authentication and processing, allowing viewing by an order fulfillment house of said orders from an order management tool, and allowing confirming of ordering and tracking information through an order tracking module.

23. An automated system for facilitating customization of garments, said automated system comprising:
a database system configured for the storage of customizing data and information;
an administration tool module configured to enable the management of said customizable data and information by an administrator to allow for adding, updating and removal of sample designs for use in an idea gallery;
a home module configured to provide at least one home page for facilitating customization, said home module comprising:
a start-designing component configured to directly initiate customization through a launch module;
a product catalog configured to offer a variety of product types and allowing searching within said product types prior to initiating said launch module; and
an idea gallery configured to lead a customer through gallery categories, provide a list of category groups, and provide exemplary artwork for idea generation prior to initiating said launch module;
a customization selection module configured to allow a customer to select and design customizable products, said customization module configured to utilize the capabilities of a local computer to facilitate substantially instantaneous design changes during customization without requiring host server interaction, said capabilities of said local computer comprising use of flash applications integrated with “html” portions and vector art applications of said automated system to provide a substantially seamless navigation process, and said flash applications being configured to individually isolate said design elements for local retrieval by a customer without requiring host server interaction; and
a plurality of order-based modules configured for facilitating ordering of said consumer products, said plurality of order-based modules comprising:
an order processing module configured to enable a customer to place orders for customized products, provide payment authentication and processing, and an order confirmation via electronic mail;
an order management tool module configured to allow an order fulfillment house to view orders, download design and update the status of orders before proceeding to manufacturing; and
an order tracking module configured to allow for returning customers to confirm shipping status; and
wherein each of said administration tool module, said home module, said customization selection module and said at least one order-based module communicatively coupled to said database system.
